(19) United States
(12) Patent Application Publication
(10) Pub. No.: US 2015/0026494 A1
(43) Pub. Date: Jan. 22, 2015

(54) INTELLIGENT MESOCHRONOUS SYNCHRONIZER

(71) Applicant: Sonics, Inc., Milpitas, CA (US)

(72) Inventors: William John Bainbridge, Mountain View, CA (US); Timothy A. Pontius, Crystal Lake, IL (US); Ivan Michal Svestka, North Riverside, IL (US); Drew E. Wingard, Palo Alto, CA (US)

(21) Appl. No.: 13/946,308

(22) Filed: Jul. 19, 2013

(51) Int. Cl. G06F 1/32

(52) U.S. Cl. CPC G06F 1/324
USPC 713/322

(57) ABSTRACT

A method and apparatus for transmitting data over a clock-gated mesochronous clock domain boundary in an interconnect network of an integrated circuit. New data is received into storage buffers within a sender domain. The data is synchronized by sending time-controlled signals from storage elements in a sender control within the sender domain to corresponding inputs in a receiver control signal path in a receiver domain. Multiplexers are signaled to sequentially transmit the data from the storage buffers across the domain boundary to the receiver domain according to the time-controlled signals received from the sender control by the receiver control signal path, where the multiplexers receive signals from a data path pointer counter in communication with the receiver control signal path.

### NOTICE OF COPYRIGHT

A portion of the disclosure of this patent document contains material that is subject to copyright protection. The copyright owner has no objection to the facsimile reproduction by anyone of the software engine and its modules, as it appears in the Patent and Trademark Office Patent file or records, but otherwise reserves all copyright rights whatsoever.

### FIELD

Embodiments of the invention generally relate to controlling power consumption of electrical systems. More particularly, an aspect of an embodiment of the invention relates to locally clock-gating a mesochronous synchronizer for a complex electrical system, including System on a Chip, to reduce power consumption during idle states of the system.

### BACKGROUND

Clock synchronization is critical when sending data from one clock domain to another clock domain in an integrated circuit as presenting data at a wrong time may cause instability of signal, thereby corrupting the data. Distances between various clock domains within the integrated circuit give rise to a shifting, or skewing of clock signals, in which the clocks continue to operate with the same frequency, but the phases of the clock signals may be different from one clock domain to another clock domain. When two clocks have the same frequency but an unknown (or differing) phase between the arriving edges of the clock signals, they are said to be mesochronous. This condition is encountered in digital logic design for a variety of reasons including the tree structure of the clock device on an integrated circuit, separate clock sources, and even physical distance between a receiving device and a sending device both supplied with a clock input from the same clock source. The bounds on the skew for the mesochronous clocks can vary. At one extreme, with rigidly controlled narrow bounds, the layout delay in the wires crossing from one timing domain to the next can be carefully managed at implementation time. At the other extreme, the two domains have to be treated as asynchronous with no bounds on the skew relationship, and that relationship possibly being allowed to change substantially at different operating conditions (voltage, frequency, temperature).

### SUMMARY

Various methods and apparatus are described for transmitting data over a gated mesochronous clock domain boundary in an interconnect network of an integrated circuit. A domain boundary includes a sender domain on one side of the boundary and a receiver domain on other side of the boundary. New data input from the interconnect is received into the sender domain, which comprises a sender data path and a sender control. The sender data path temporarily stores the new data in a multiplicity of storage buffers, and the sender control utilizes clock-gating signals to validate the data. The data is synchronized by sending time-controlled signals sequentially from a multiplicity of storage elements within the sender control to corresponding inputs in a receiver control signal path within the receiver domain. One or more multiplexers within the data path are signaled to sequentially transmit the data from the storage buffers across the domain boundary to the receiver domain according to the time-controlled signals received through the inputs in the receiver control signal path. At least one of the inputs in the receiver control signal path includes a free running flop, which creates a delay between the transmission of the control signals from the sender control and the reading of the controls signals in the receiver control signal path. The delay minimizes the possibility of corrupted data transmission across the domain boundary.

Moreover, the sender control and the receiver control signal path are locally clock-gated independently when 1) there is no new data being presented to the sender control or the receiver control signal path, 2) the sender control or the receiver control signal path is at a predetermined initialization state, and 3) the sender control or the receiver control signal path is idle for a predetermined number of clock cycles. The sender domain and the receiver domain can each be powered independently and/or initialized independently of one another provided the other domain meets the three conditions described.

### BRIEF DESCRIPTION OF THE DRAWINGS

The drawings refer to embodiments of the design in which:

FIG. 1 illustrates a block diagram of an embodiment of an integrated circuit, such as System-on-a-Chip.

FIG. 2 illustrates a mesochronous domain crossing communication interface, including a sender domain and a receiver domain.

FIG. 2A illustrates another embodiment of a mesochronous domain crossing communication interface, which includes a sender domain and a receiver domain.

FIG. 2B illustrates another embodiment of a mesochronous domain crossing communication interface, including a sender domain and a receiver domain.

FIG. 3A is a timing diagram of the mesochronous clock signals between the sender domain of the interface and the receiver domain.

FIG. 3B is another timing diagram of the mesochronous clock signals between the sender domain of the interface and the receiver domain.

FIG. 4 illustrates a flow diagram of an embodiment of an example of a process for generating a device, such as a System on a Chip, in accordance with the systems and methods described herein.

While the design is subject to various modifications and alternative forms, specific embodiments thereof have been shown by way of example in the drawings and will herein be described in detail. The design should be understood to not be limited to the particular forms disclosed, but on the contrary, the intention is to cover all modifications, equivalents, and alternatives falling within the spirit and scope of the design.

### DETAILED DISCUSSION

In the following description, numerous specific details are set forth, such as examples of specific data signals, named components, connections, number of memory columns in a group of memory columns, etc., in order to provide a thorough understanding of the present design. It will be apparent, however, to one of ordinary skill in the art that the present design may be practiced without these specific details. In other instances, well known components or methods have not been described in detail but rather in a block diagram in order to avoid unnecessarily obscuring of the present design. Further specific numeric references such as first driver, may be made. However, the specific numeric reference should not be interpreted as a literal sequential order but rather interpreted that the first driver is different than a second driver. Thus, the specific details set forth are merely exemplary. The specific details may be varied from and still be contemplated to be within the spirit and scope of the present design. The term coupled is defined as meaning connected either directly to the component or indirectly to the component through another component.

In general, multiple features of or useable with a payload crossing synchronizer are described. The payload crossing synchronizer includes a sender module on one side of a boundary and a receiver module on the other side of the boundary. The sender module has a storage buffer, which is clocked at a write clock frequency. The sender module also has one or more multiplexers to pass the data payload over to a receiver storage register in the receiver module, which is clocked at a read clock frequency. Each of the one or more multiplexers on the sender domain side of the boundary has 1) its own read address pointer lane coming from sequencing logic located on the receiver control signal path and 2) its own data payload lane to send data payload from that multiplexer across the boundary to the receiver storage register on the receiver control signal path in a qualified event synchronization. The source of the write clock frequency clocking the storage buffer feeding data payload to the multiplexers is separate from a source of the read clock frequency clocking the receiver storage register, so that the two clocks may have either a mesochronous relationship or a synchronous relationship. The sequencing logic ensures that the multiple read address pointers going to the one or more multiplexers have a fixed alternating relationship amongst themselves to be able move the data payload across the boundary to provide one hundred percent throughput from the sender module to the receiver module, as measured on the receiver control signal path based on a capacity of the sender domain to supply that amount of data payload.

In general, in an interconnection network, there are a number of heterogeneous initiator agents (IA) and target agents (TA) and routers. As the packets travel from the initiator agents to the target agents in the interconnect network, they travel through a multitude of power domains, clock domains, voltage domains, and partitioning boundaries. The sequencing logic allows the alignment of functional-reset, hardware-reset, and idle states such that idle can be used to clock-gate, while one half of the synchronizer component is ignorant of whether the other part is powered off. The sequencing logic allows an aggressive clock-gating of a mesochronous bridge, achieving a power-metric of one free running flop per mesochronous bridge design/instantiation. Many mesochronous bridge instantiations may exist per system, for example, so many free running flops may be eliminated in an interconnect design.

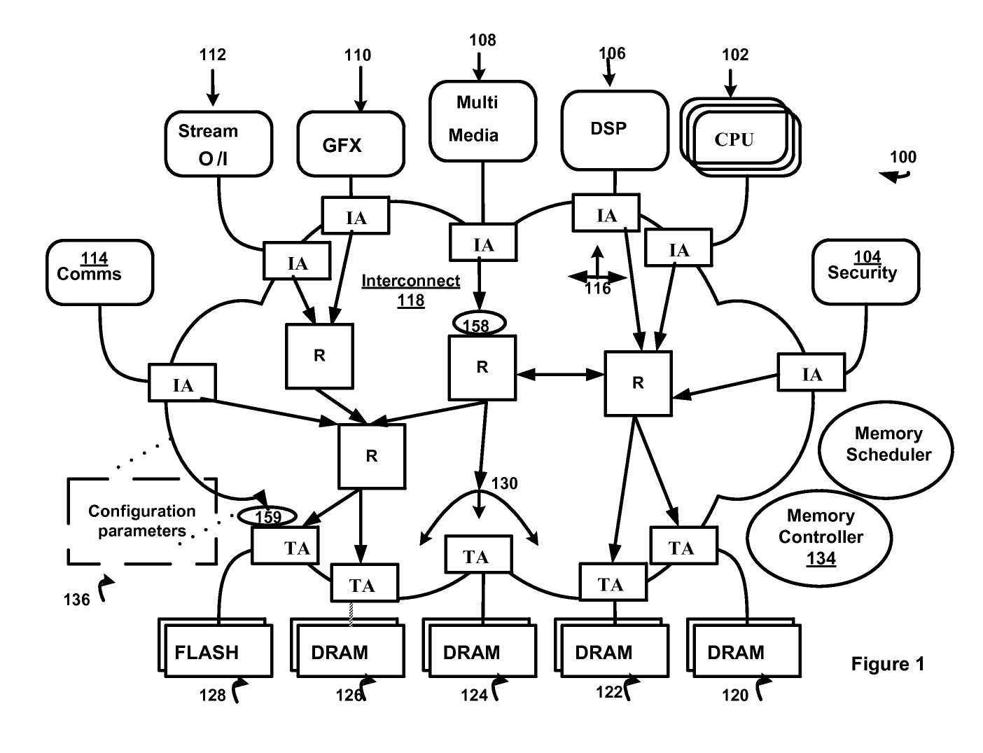

FIG. 1 illustrates a block diagram of an embodiment of an integrated circuit, such as System-on-a-Chip. The integrated circuit 100 includes multiple initiator Intellectual Property (IP) cores and multiple target IP cores that communicate read and write requests as well as responses to those requests over a network on the chip/interconnect network 118. The interconnect network 118 may also be referred to as a packet-based switch network because the data transferred within the interconnect network 118 is in the form of packets. Some examples of initiator IP cores may include a CPU IP core 102, an on-chip security IP core 104, a digital signal processor (DSP) IP core 106, a multimedia IP core 108, a graphics IP core 110, a streaming input-output (I/O) IP core 112, a communications IP core 114 (e.g., a wireless transmit and receive IP core with devices or components external to the chip, etc.), etc.

Each initiator IP core may have its own initiator agent (IA) (e.g., 116, etc.) to interface with the interconnect network 118. Some examples of target IP cores may include DRAM IP core 120 through DRAM IP core 126 and FLASH memory IP core 128. Each target IP core may have its own target agent (TA) (e.g., 130) to interface with the interconnect network 118. Each of the DRAM IP cores 120-126 may have an associated memory controller 134. Similarly, the flash memory 128 is associated with a flash controller. All of the initiator IP cores 102-114 and target IP cores 120-128 may operate at different performance rates (i.e. peak bandwidth, which can be calculated as the clock frequency times the number of data bit lines (also known as data width), and sustained bandwidth, which represents a required or intended performance level). Further, routers in the interconnect fabric 118 may operate at different performance levels. Portions of the interconnect network 118, memory controller 134, and potentially the memory scheduler may be laid out in different layout partitioning blocks. Portions of the interconnect network, memory controller 134, and potentially the memory scheduler may be in different power domains. The interconnect network 118 illustrates some example routers where the information flows from the initiator IP cores and initiator agents to the target agents and target IP cores. Although not illustrated, there is a corresponding response network that connects the target IP cores and the target agents to the initiator agents and initiator IP cores. The routers may be used to route packets within the interconnect network 118 from a source location (e.g., the initiator IP cores 102-114) to a destination location (e.g., the target IP cores 120-128) in the integrated circuit. The number of routers may be implementation specific (e.g., topology used, area requirement, latency requirement, etc.). The data sent from the initiator IP core 102 to the target IP core 122 may be packetized by packetizing logic associated with the IA 116 before being sent into the interconnect network 118. The packets may pass through the routers. The packets may then be depacketized by depacketizing logic associated with the target agent 130 when they leave the interconnect network 118.

The network on a chip/interconnect network 118 implements many concepts including one or more of: a credit flow control scheme in a router with flexible link widths utilizing minimal storage; use of common data formats to facilitate link width conversion in a router with flexible link widths; low cost methods to achieve adaptive transaction and packet interleaving in interconnection networks; efficient schemes to quiescence and wakeup power management domains in a highly partitioned NoC Based SoC; mesochronous and asynchronous synchronizers with credit based flow control; an area efficient mesochronous synchronizer design; as well as many additional concepts.

A first instance of a payload crossing synchronizer 158 may be located at a first boundary in the interconnect network 118 in the integrated circuit 100. A second instance of the payload crossing synchronizer 159 may be located at a second boundary in the interconnect network 118, and so on. The type of payload crossing synchronizer placed at the first and second boundaries is individually selectable at design time via configuration parameters. In one embodiment, the payload crossing synchronizer 158 may be a mesochronous domain crossing communication interface that is tolerant of the skew between the clocks.

It will be appreciated by those skilled in the art that clock synchronization is of critical concern when sending data from one domain to another domain. Presenting data at a wrong time, or losing synchronization of the data may cause metastability of signals, thereby causing data corruption. Distances between various domains within the interconnect network 118 give rise to mesochronous clock signals, in which the clocks continue to operate with the same frequency, but the phases of the clock signals may be different, or skewed, from one domain to another domain. Moreover, in some instances clock skew may arise due to the physical clock tree layout within the integrated circuit 100.

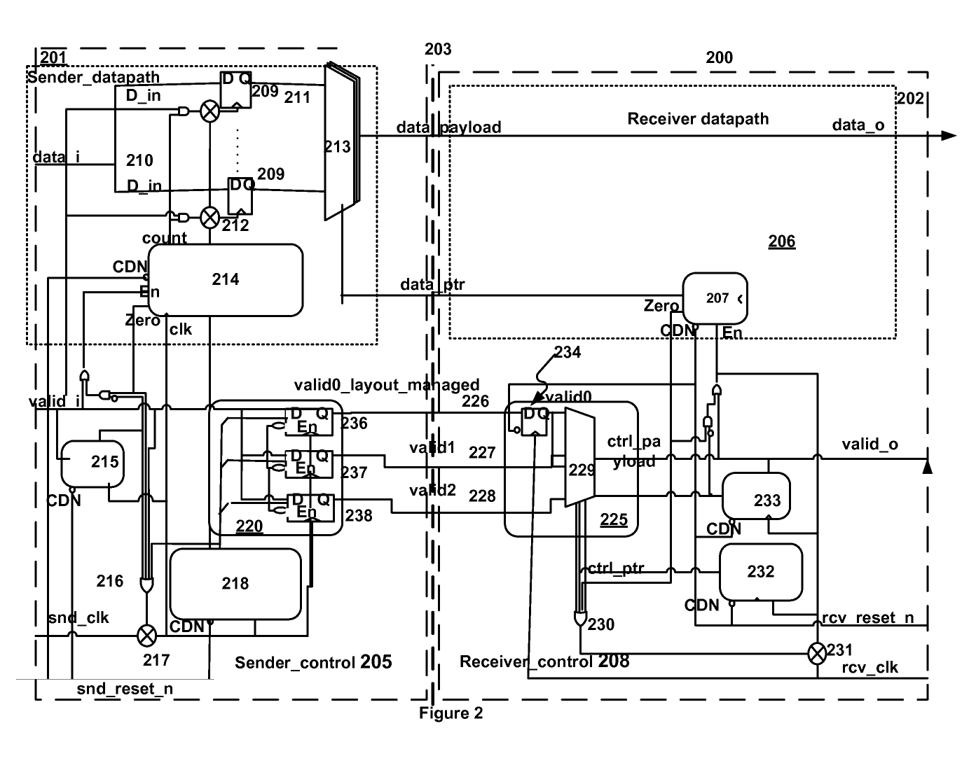

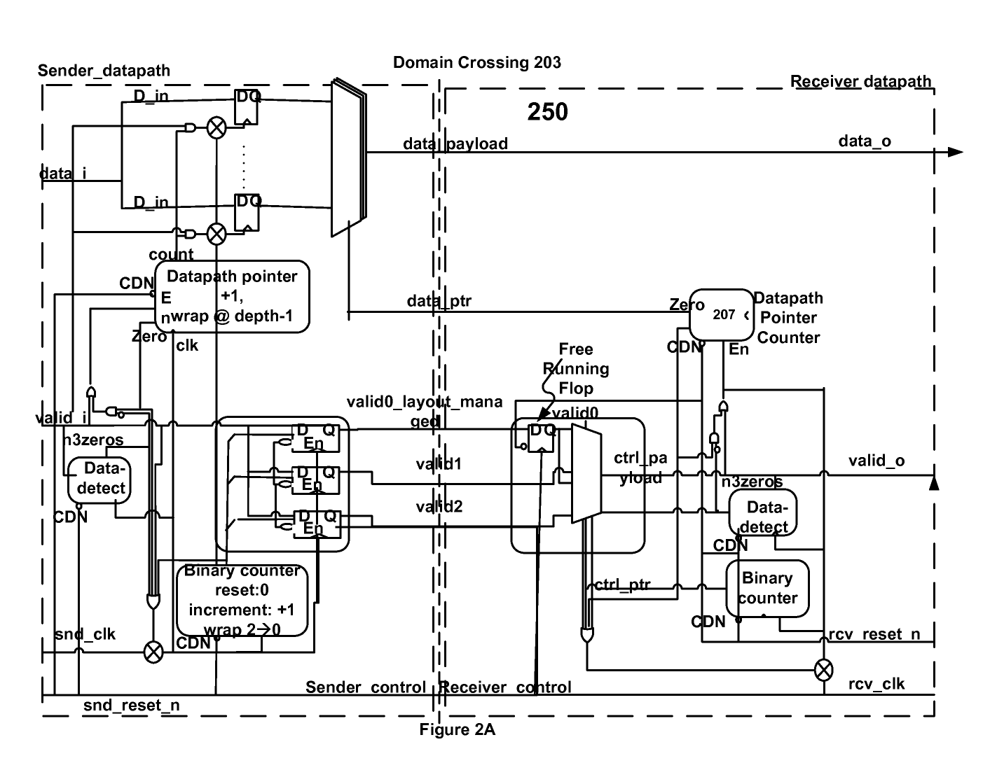

FIG. 2 illustrates one exemplary embodiment of a mesochronous domain crossing communication interface 200, comprising a sender domain 201 and a receiver domain 202. The sender domain 201 receives new data input from the interconnect 118 and must communicate the data, synchronized, across a mesochronous clock domain boundary 203 to the receiver domain 202. The sender domain 201 is comprised of a sender data path 204 and a sender control 205. The sender data path 204 communicates the data across the domain boundary 203, and the sender control 205 utilizes clock-gating signals to control the validity and transmission of the data to the receiver domain 202. The receiver domain 202 comprises a receiver data path 206, which includes a datapath pointer counter 207, and a receiver control signal path 208. The receiver control signal path 208 uses clock controller logic to function as a payload data validity controller. The datapath pointer counter 207 signals the sender data path 204 to transmit data across the domain boundary 203 when signaled by the receiver control signal path 208. In the illustrated embodiment, the sender domain 201 and the receiver domain 202 can be initialized independently of one another. Likewise, each of the sender domain 201 and the receiver domain 202 may be independently placed into a reduced power, or idle, state without affecting one another. Thus, it will be appreciated that the embodiment illustrated in FIG. 2 eliminates a need to reset and initialize both the receiver domain 202 and the sender domain 201 when only one of them has been powered-off.

Typically, the sender domain 201 will be in a first clock domain controlled by the power management of that first clock domain and the receiver domain will be located in a second clock domain under the control of the power management that's controlling that second clock domain. The mesochronous domain crossing communication interface 200 may be generally located within a block of logic at links/router locations within the interconnect 118. The mesochronous domain crossing communication interface 200 may also be located at the agents 116 or 130 feeding into the interconnect 118. It will be recognized that the mesochronous domain crossing communication interface 200 may be used in other areas of the integrated circuit 100 than discussed above, such as outside of the interconnect 118.

During operation, the sender data path 204 transmits new data from the interconnect 118 into a multiplicity of storage elements, such as D-type flip flop buffers 209. Each of the buffers 209 comprises a D-input 210, a Q-output 211, and a clocked input 212. The sender data path 204 further comprises a multiplexer 213 and a send counter 214. The multiplexer 213 receives data from the buffers 209 and transmits the data to the receiver domain 202 when a signal to do so is received from the datapath pointer counter 207. The send counter 214 ensures that the buffers 209 are accessed sequentially, one at a time. In other embodiments, the sender data path 204 may be comprised of more than one multiplexer 213, as well as more than the number of buffers 209 shown in FIG. 2. Moreover, although the multiplexer 213 is shown in FIG. 2 to be within the sender domain 201, it will be appreciated that the multiplexer 213 alternatively may be placed within the receiver domain 202. Still, in another embodiment, the multiplexer 213 may be placed between the receiver domain 202 and a downstream receiving flop outside of the modules illustrated in FIG. 2.

The sender control 205 comprises a detector 215 which analyzes a sequence of inputs to the sender data path 204 for a predefined number of cycles. The detector 215 communicates its results through a logical OR gate 216 to a clock-gating latch 217. The clock-gating latch 217 feeds a binary counter 218 which sequentially selects one of a multiplicity of storage elements 236, 237, and 238 within a storage portion of a first-in-first-out (FIFO) storage mechanism 220 that sends stored control data to the receiver control signal path 208. As discussed below, upon receiving the stored control data, the receiver control signal path 208 and the datapath pointer counter 207 signal the sender data path 204 to present the data on an output data_o, safely moving it from the sender clock-domain to the receiver clock-domain. When the detector 215 determines that a predetermined number of consecutive idle cycles have occurred, the sender control 205 and 218 is returned to a predetermined initialization state. In one embodiment, the detector 215 may determine that no new data has been input to the sender data path 204, or is being processed thereby, when only zeros are detected as input for a number of cycles equal to the number of buffers 209.

In one exemplary embodiment, the receiver control signal path 208 comprises a read port portion of a FIFO 225, which includes a free running flop 234 and a multiplexer 229. It will be recognized by those skilled in the art that although the storage portion of the FIFO 220 and the read port portion of the FIFO 225, including the free running flop 234 and the multiplexer 229, are discussed herein and illustrated in FIG. 2 as though they are separate, individual components, these components should be understood as comprising specific portions within the FIFO storage mechanism. The components illustrated in FIG. 2 are treated individually herein merely for the sake of clarity of discussion.

The multiplexer 229 receives the stored control data from the storage elements 236, 237, and 238, respectively through a first input 226 and the free running flop 234, a second input 227, and a third input 228. It will be appreciated that the multiplexer 229 preferably includes a number of inputs equal the number of storage elements 236, 237, and 238 in the sender control 205. It is envisioned that in other embodiments, the multiplexer 229 and the storage portion of the FIFO 220 may include more or less than the number of inputs illustrated in FIG. 2.

The free running flop 234 receives control information data from the storage element 236, coupled with information from the datapath pointer counter 207. The multiplexer 229 passes information from the inputs 226, 227, and 228 through a logical OR gate 230 to a clock-gating latch 231 that controls the clock to a binary counter 232, and a detector 233. The detector 233 determines whether all the data received has been transmitted, or is being processed thereby, and the binary counter 232 ensures that the multiplexer 229 reads data on the inputs 226, 227, and 228 sequentially, one at a time. Each time data is read on one of the inputs 226, 227, and 228, the datapath pointer counter 207 signals the multiplexer 213 to transmit data from the corresponding buffer 209 across the domain boundary 203. Once the detector 233 determines that a predetermined number of idle cycles have taken place, the receiver control signal path 208 and counter 232 are returned to a predetermined initialization state. In one embodiment, the detector 233 is a simple counter that is loaded each non-idle cycle and decremented each idle cycle until it hits zero. In another embodiment, the detector 233 is a shift-register containing the same number of flip-flops as the storage portion of FIFO 220, arranged in sequence, with a logical OR-gate detecting when the shift-register is empty.

In an exemplary embodiment, the free running flop 234 is at least one storage element of the read port portion of the FIFO 225, operating on the receiver clock, and is not controlled by the receiver domain clock-gating control. Thus, the free running flop 234 is always clocked. As illustrated in FIG. 2, the free running flop 234 is in the path between the storage element 236 that is written when addressed by the sender-domain pointer when at its initialization value and the multiplexer 229 is indexed by the receive-domain pointer. In other embodiments, more than one free running flop in series may be used in conjunction with more than one of the storage elements of the storage portion of the FIFO 220. For example, the multiple free-running flops in series used in conjunction with multiple storage locations are all used in conjunction with the storage location indexed by the pointers when in their initialization state.

It should be understood that the free running flop 234 ensures a latency delay between the transmitting of data by the sender control 205 and the reading of the data by the receiver control signal path 208. The latency delay minimizes the possibility of corrupted data being transmitted across the domain boundary 203. In one embodiment, the latency delay is between slightly greater than zero clock-cycles and less than two clock-cycles. In other embodiments, in which the architectural designer can guarantee, due to physical distances or a layout of the clock tree, that the clock skew will never be greater than one clock-cycle, the free running flop 234 may produce a latency delay of a single clock-cycle between the transmitting and reading of data. Once the initial latency delay has passed, then the control data in all the storage elements 236, 237, and 238 is sequentially transmitted to the multiplexer 229, and correspondingly all the data in the buffers 209 is sequentially transmitted across the domain boundary 203.

In an alternative embodiment, the combination of the zero-detect 215 and the OR-gate 216 may be re-factored to use an additional state-holding element to ‘sample’ the state of the system each time the pointer 218 points at the control signal path 236 that leads to the free-running flop 234. The receiver-side logic may be similarly restructured. This small amount of extra complexity decreases the latency delay required for each of the sender control 205 and the receiver control signal path 208 to enter into a reduced power, idle state after performing the last active transfer.

In the exemplary embodiment of FIG. 2, both the sender control 205 and the receiver control signal path 208 may independently reduce local clocking power by way of respective clock-gating latches 217 and 231. Thus, the mesochronous domain crossing communication interface 200 may be clock-gated locally to a reduced power, idle state by either the sender control 205 or the receiver control signal path 208 when 1) there is no new control data presented to the sender control 205 or the receiver control signal path 208, 2) the sender control 205 or the receiver control signal path 208 is at the predetermined initialization state, and 3) each of the immediately preceding predetermined number of cycles in either the sender control 205 or the receiver control signal path 208 was idle. It will be appreciated that the predetermined number of cycles corresponds to the number, or depth, of the storage elements 236, 237, and 238 of the storage portion of the FIFO 220 and the corresponding inputs 226, 227, and 228 in the read port portion of FIFO 225. It is envisioned that in other embodiments the depth of the FIFO formed by 220 and 225 may be larger or smaller than as illustrated in FIG. 2, and that the depth may be tailored to account for various degrees of clock skew. Moreover, it should be understood that the storage elements 236, 237, and 238 may comprise flip flops, latches, or other similar storage devices.

It will be recognized that in the mesochronous domain crossing communication interface 200 of FIG. 2, the sender data path 204 and the receiver data path 206 are respectively separated from the sender control 205 and the receiver control signal path 208. The datapath send counter 214 and the datapath receive counter 207 index into the storage of 209 and the multiplexer 213 to form a FIFO for controlling data in the order it is written into the elements 209. The progression of the counters 214 and 207 is controlled by the sender control 205 and the receiver control 208 such that the datapath counters 214 and 207 only change when a non-idle value is written/read on three control path, indicating that there is data to be written/read on the same clock cycle in the data path. Moreover, the binary counters 218 and 232 wrap at the number of storage elements within the FIFO formed by 220 and 225. Thus, the illustrated embodiment enables the use of a different number of buffers 209 than the number of storage elements within the FIFO formed by 220 and 225. For example, one embodiment may utilize two buffers 209, the three storage elements 236, 237, and 238, and the three inputs 226, 227, and 228 in the FIFO formed by 220 and 225, provided no more than two entries are written to the storage elements 236, 237, and 238 in any single count iteration through the storage elements 236, 237, and 238. The illustrated embodiment of the mesochronous domain crossing communication interface 200, therefore, may be configured to fit into a smaller area within the interconnect 118 than other conventional interface circuits.

Moreover, since the sender control 205 and the receiver control signal path 208 are separated from one another, their respective pointer counters, 218 and 232, do not need to count every clock-cycle and may be clock-gated into a reduced power, idle state once the sender control 205 or the receiver control signal path 208 has returned to the predetermined initialization state. It will be recognized that putting the pointer counters 218 and 232 into the idle state is beneficial in systems where sustained continuous data transfers every clock-cycle are not required. Another benefit to clock-gating the pointer counters 218 and 232 is a reduction of the number of free-running control-signals that must be maintained when no data is being transferred. In this embodiment, only the free running flop 234 must be carefully timing-managed during implementation to avoid metastability, and the pointer counters 218 and 232 are allowed to free-run only when the sender control 205 or the receiver control signal path 208 respectively is active. In another embodiment, a credit-based data flow-control mechanism may be used where the sender domain 201 will never send data unless the receiver domain 202 is ready to receive it, and a ‘credit-count’ enables restriction and certainty of the maximum number of transfers in a given time window. Providing that the sender control 205 and the receiver control signal path 208 are both in the idle state before either one of the controls 205 and 208 is reset, there is no need for a bidirectional synchronization between the two controls 205 and 208, thereby eliminating the cost and power consumption of additional synchronizers. The synchronizer allows an alignment of the functional-reset, hardware-reset, and idle states such that idle can be used to clock-gate, while one half of the synchronizer component is ignorant of whether the other part is powered off.

In another embodiment, a predictive mechanism may be incorporated into the interface 200, which indicates to the local clock-gating control that the sender domain 201 is about to receive new data. This allows the clock-gating control to reset or start the initialization of both the sender domain 201 and the receiver domain 202 of the mesochronous domain crossing communication interface. Utilizing the predictive mechanism indicates when new data will arrive at least one clock-cycle in the future, and then enables initialization to occur while the data arrives into the sender domain 201, avoiding any startup-delay.

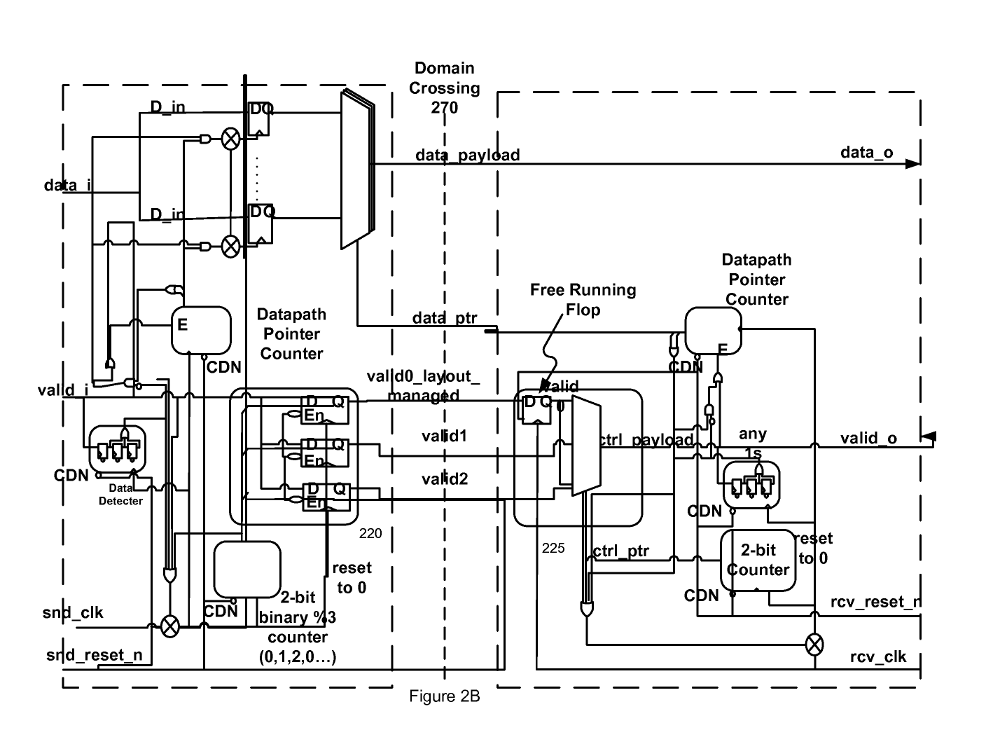

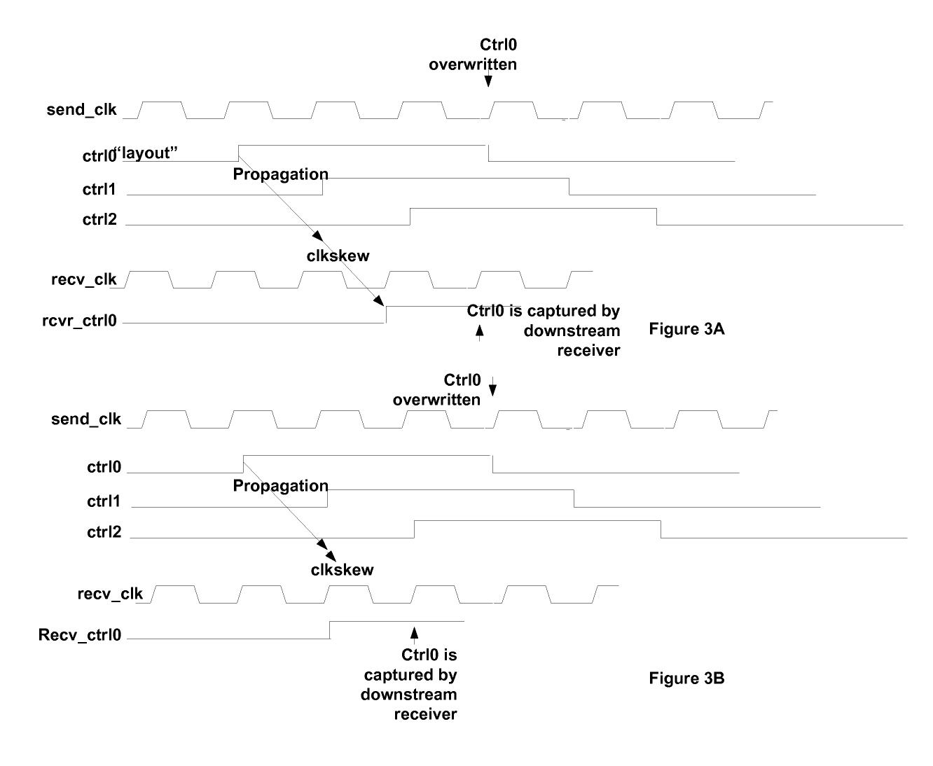

FIGS. 3A and 3B illustrate the timing of the mesochronous clock signals between the sender domain 201 of the interface 200 and the receiver domain 202. The clock signals between the two mesochronous clock domains have the same shape and frequency but the leading edge of the phase may be offset. Because of the physical distance between the sending device and the receiving device on the integrated circuit, the leading edges of phases of the clocking signal may be askew or offset. Also, because of the physical clock tree layout sometimes the leading edges of the phases between the two clock signals may be offset. As an example, FIG. 3A shows that the leading edge of the clock signal on the receiving side comes slightly before the leading edge of the clock signal on the sending side. In practice without the free running flop, this would mean on this clock cycle that the sending side will be trying to write/send data to the receiving side after the receiving side has begun reading that data. However, the Q output of the free running flop does not change until properly clocked on its gate input. Thus, the Q output of the free running flop merely can represent the new data being sent only after the leading edge of the sender clock signal has occurred. This delay, the sum of propagation and clock-skew delays each of which may vary between zero and almost one clock period may be a delay of between 1) slightly greater than zero cycles after the leading edge of the sender clock occurs and up to 2) slightly less than two full clock cycles after the leading edge of the sender clock occurs.

Accordingly, the free running flop 234 is added between the sending side and the receiving side to ensure that a latency of anywhere from greater than 0 clock cycles but less than 2 clock cycles is inserted between the writing/sending of that control information data and associated data and the reading/receiving of that control information data and associated data. The latency delay minimizes the possibility of corrupted data being sent and received. The tighter the bounds on the skew for the mesochronous clocks, the simpler and cheaper the logic can typically be. Note, also, after the initial latency delay, then all of the data for that sequence will be transferred across the domain crossing in lock step sequence. Thus, if a related sequence of 4 sets of data and control information were communicated across the domain crossing, then merely a single cycle of latency total would be incurred for the complete transfer of those 4 sets of data.

The mesochronous domain crossing communication interface that has a gated clock has a separation of a data path from a control path. In this scheme, the free-running pointers are used to transfer a control signal that indicates the presence of a valid entry in a separate data-store. An independent counter is used by each of the sender and receiver control signal paths to index into the data store, they are incremented when a valid item is written/read and wrap at the size of the datastore. Thus, it is possible to use e.g. a 2-slot datastore with a 3-slot control-FIFO, provided no more than 2 entries are written in any 3-cycle window. This approach allows a lower-area solution compared to a classical approach. Also, the pointer counters do not need to count every clock-cycle and may enter the idle state once that side has entered back into it known initialization value. This is beneficial in systems where there is not a requirement to be able to sustain continuous data transfers every clock cycle. In the context of the interconnect, the link-protocol may use a credit-based flow-control mechanism meaning that the sender will never send data unless the receiver is ready to receive it, and the ‘credit-count’ of the link allows restriction and certainty of the maximum number of transfers in a given time window.

The mesochronous domain crossing communication interface has a gated clock that allows clock-gating the pointer counters that are conventionally free-running. This approach still retains the desirable property of only a small number of control-signals (e.g., one illustrated in FIG. 2) having to be carefully layout-timing managed to avoid metastabilty.

The key concept that allows this approach to work is the idea that the sender side or receiver side logic only gates its clock off when it sees that the FIFO is idle and in a state that matches its initialization state. For the control FIFO this means: the pointer is zero and the FIFO has all-zeros within it (which can be inferred by seeing 3 zeros in sequence on the write input signal or read output signal). This allows the counters to only free-run when the system is active. While idle, the clocks can be gated to all flops except for those in the receiver on the layout-timing-managed paths. Provided the unit will always be idle before one half is reset (or powered-off, then on, then reset), then this avoids the need for a synchronized handshake between the two halves, avoiding the cost of the synchronizers.

When using a separate data path as illustrated in FIGS. 2, 2A, and 2B, the condition for clock-gating can be further complicated since to support the simplified reset approach, the data-pointers must also be zero. This can be achieved by either continuing to run the control-path clock longer, and advancing the datapath counter until it reaches the initialization value, or by forcibly resetting it.

The mesochronous domain crossing communication interface that has a gated clock may achieve a power-metric of one free running flop per design. The power management protocol managed locally by the logic within the interface allows the system to aggressively clock-gate this mesochronous interface, which achieves a power-metric of one free running flop per design. An interconnect within an Integrated circuit may have many of these communication interfaces with free running flops in some designs, so this number gets multiplied up quite quickly. The mesochronous domain crossing communication interface that has a gated clock allows for a design with a fewer number of free running flops which achieves an idle power state that allows a lower metric of power consumption. The mesochronous domain crossing communication interface that has a gated clock grants greater battery life to a Mobile device using an integrated circuit with the mesochronous domain crossing communication interface.

The mesochronous domain crossing communication interface that has a gated clock may use an alignment of functional-reset, hardware-reset and idle states such that idle can be used to clock-gate one side of the communication interface ignorant of whether the other side is powered off or not.

The mesochronous domain crossing communication interface that has a gated clock can bridge between two mesochronous domains which will not need to both be reset at the same time. This can be a problem for other designs when the sender and receiver are operating in different power-domains where one half may be powered off whilst the other half is still powered on. Consequently, e.g., if the left half is powered on, then later the right half transitions from off to on, the right half is initialized using its receiver reset input, this must be synchronized by the sender-half and used to initialize that sender part too.

The mesochronous domain crossing communication interface that has a gated clock will generally be located at the links/routers within the interconnect but may be located at any mesochronous clock relationship between a sending device and receiving device where the phases of the leading edge of the clock signal may be unknown.

The mesochronous domain crossing communication interface that has a gated clock also avoids sending of corrupt data between the sender domain 201 and receiver domain 202 of the interface; and thus, eventually between the sending device and receiving device.

The free running flop 234 in the read port portion of the FIFO 225 is not located in the separate initialization path between the receiving and sending device, which a power manager normally uses to initialize a mesochronous bridge. Instead, the free running flop 234 is located in the normal control clock synchronization path between the receiver domain 202 and sender domain 201 of the communication interface 200. The detector was added to detect when new data is flowing into the sender domain of the communication interface 200 and will be sent over to the receiver control signal path from the sender domain.

The mesochronous domain crossing communication interface 200 also by design separated out the logic and flow path/signal wiring of the data flow from the logic and signal wiring paths of the clock control path that indicates and governs the validity of that data.

Most times, in mesochronous domain crossing, counters and clocks of that interface must be kept running and are not really allowed to go to an idle or powered down state unless both sides go to the power down state. The mesochronous domain crossing communication interface that has a gated clock uses fewer free running flops in order to reduce power consumption while ensuring data corruption is avoided, as well as has a lower latency than an asynchronous synchronizer bridge.

The free running flop ensures that the corrupt data is not communicated across the mesochronous clock domain by essentially not accepting the control information and data from the sender domain until after the leading edge of the clock on the sender domain 201 occurs.

The two sides do not need to know what activity state the other side is in (i.e., idle or initialized) via some separate communication signal other than the actual control information data signals going back and forth between the free running flop and the logic on both sides that monitor what's going on from the other side. The logic makes sure that either side can reset merely when that other side is idle. Valid new data is allowed to be written from the sender side after the receiver control signal path is verified to be at the initialization value of the known initialization value.

The mesochronous domain crossing communication interface that has a gated clock has a flexible mesochronous crossing that has very relaxed bounds on the clock-relationship, which for example uses a 3-slot FIFO with separate read and write pointers that are initialized such that a slot is guaranteed to never be read until after it has safely been written, for a clock skew range of +/−one clock period. This scheme thus allows crossing between the two clock-domains of an arbitrarily wide signal vector whilst only having to manage the timing of a single control signal, track the state to initialization, and activity of transactions being processed/anticipated to be processed.

The local protocol power management protocol logic allows the removal of the linked-up handshake path signal wiring and logic that includes a couple of free running flops that were used for synchronization in a previous instantiation. Referring to the lower clock control mechanism the three zeros detectors determines that no new data is flowing into the sender domain of the communication interface by detecting a series of three zeros coming in to that detector. A binary counter for the clock path chooses what storage slot should be being read in order to pass over the validity signal to the receiver control signal path. The binary counter sends a signal up to the storage portion of the FIFO 220 with its three slots of storage. Those signals determine which slot should be read in the storage/structure to be sent over to the receiver control signal path.

The first slot, slot 0, storage element/flop on the sender domain has a Q output that has a signal wire linked to the input of the free running flop 234 located in the read port portion of the FIFO 225 on the receiver control signal path. When that output goes high, then the free running flop 234 knows that the sender domain is at the known initialization value. This is because by system design that slot's storage element, for example slot 0, has been pre-selected as the known initialization value for both the sender domain and the receiver control signal path.

The circle with an X after the four input logical OR gate is a clock gating latch. The clock gating latch makes sure that the clocking out of the gate occurs on a cycle by cycle basis. The four input logical OR gate is used to communicate to the power management software that all three of the conditions for the local power management protocol have been met such that this side can now be put into idol or go to sleep.

The three conditions are; firstly, a reading of valid data on the receiver control signal path can only start after the leading-edge of the clock cycle gates/enables the sender domain to sending the data and associated control information. This ensures that the receiver is only reading valid data that has been sent by the sender domain and is not reading data stored and out of date from a previous cycle.

Secondly, each side cannot be clock gated to sleep until the counters have cycled through to achieve their pre-selected known value, which is the same as the initialization value. The counter controls which storage slot is sending data to the receiver control signal path. Thus, the counter is choosing which storage slot is feeding data to the receiver control signal path on that cycle. The chosen, for example, storage slot of known initialization value would be slot 0 and until the pointer of the counter sends an enable signal to storage slot 0, only then can the sender domain or receiver control signal path go to sleep and become idle. And, thirdly, that side must be empty of dataflow items being processed by that side.

The free running flop 234 is added in the main control signal path rather than a separate hand-shaking path. The free running flop ensures a delay of at least greater than zero clock cycles occurs between the sending of the valid data and control information to the receiver and the reading of that valid data from the receiver control signal path. In other words, the latency may be plus or minus 1 cycles skewed relative to the other side.

In the sender data path 204, a counter for the data path exists, as well. The algorithm may be the data path pointer is plus 1 wrap at the depths of the slots, minus 1. The free running flop 234 is contained within the read port portion of the FIFO 225 of the mesochronous domain crossing communication interface 200. Typically, the sender domain will be in a first domain controlled by the power management of that first domain and the receiver control signal path will be in a second domain under the control of the power management device that's controlling that second power domain.

The mesochronous domain crossing communication interface 200 may be generally located in a block of logic at links/router locations within the interconnect. The mesochronous domain crossing communication interface may also be located at the agents feeding into the interconnect. The mesochronous domain crossing communication interface may be used in other areas of an interconnect outside of the interconnect but still with inside an integrated circuit.

The design in an alternative embodiment, may also use a predictive mechanism to bring to the attention of the power management logic within the communication interface one cycle earlier that new data is about to come into the sender domain, which would reset or start the initialization on both sides of the mesochronous domain crossing communication interface. The predictive scheduler indicates new data will be coming at least one cycle in the future, and then initialization can occur when the data is actually arriving instead of waiting for the initialization after the arrival of the new data.

Additionally one or two free running flops may be located inside the read port portion of the FIFO 225 on the receiver control signal path. When a second a free running flop is added on the receiver control signal path, then the number of potential cycles that the system has to wait until a known value of initialization occurs is decreased, because both of those free running flops tied to outputs on the sender domain will be connected to flops on the receiver control signal path and this will communicate when both sides are at the same initialization value.

### Simulation and Modeling

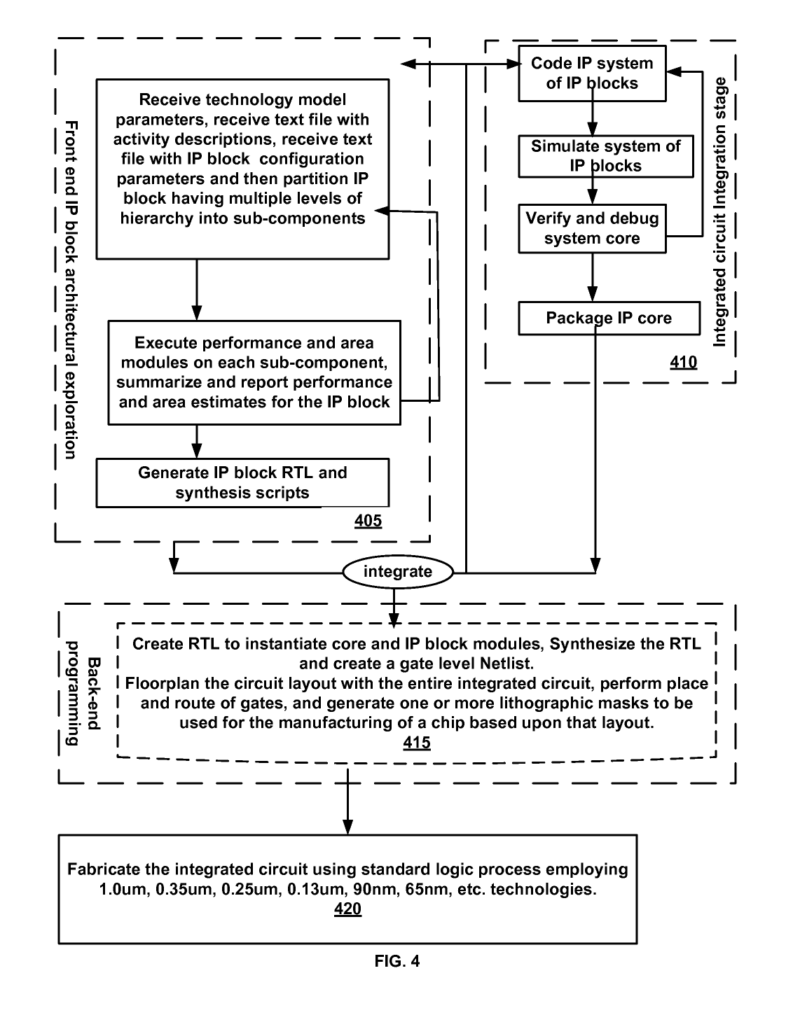

FIG. 4 illustrates a flow diagram of an embodiment of an example of a process for generating a device, such as a System on a Chip, in accordance with the systems and methods described herein. The example process for generating a device with designs of the Interconnect and Memory Scheduler may utilize an electronic circuit design generator, such as a System on a Chip compiler, to form part of an Electronic Design Automation (EDA) toolset. Hardware logic, coded software, and a combination of both may be used to implement the following design process steps using an embodiment of the EDA toolset. The EDA toolset such may be a single tool or a compilation of two or more discrete tools. The information representing the apparatuses and/or methods for the circuitry in the Interconnect, Memory Scheduler, etc. may be contained in an Instance such as in a cell library, soft instructions in an electronic circuit design generator, or similar non transitory machine-readable storage medium storing this data and instructions, which, when executed by a machine, cause the machine to generate a representation of the apparatus. The information representing the apparatuses and/or methods stored on the machine-readable storage medium may be used in the process of creating the apparatuses, or model representations of the apparatuses such as simulations and lithographic masks, and/or methods described herein. An Electronic Design Automation (EDA) toolset may be used in a System-on-a-Chip design process that has data and instructions to generate the representations of the apparatus.

Aspects of the above design may be part of a software library containing a set of designs for components making up the scheduler and Interconnect and associated parts. The library cells are developed in accordance with industry standards. The library of files containing design elements may be a stand-alone program by itself as well as part of the EDA toolset.

The EDA toolset may be used for making a highly configurable, scalable System-On-a-Chip (SOC) inter block communication system that integrally manages input and output data, control, debug and test flows, as well as other functions. In an embodiment, an example EDA toolset may comprise the following: a graphic user interface; a common set of processing elements; and a library of files containing design elements such as circuits, control logic, and cell arrays that define the EDA tool set. The EDA toolset may be one or more software programs comprised of multiple algorithms and designs for the purpose of generating a circuit design, testing the design, and/or placing the layout of the design in a space available on a target chip. The EDA toolset may include object code in a set of executable software programs. The set of application-specific algorithms and interfaces of the EDA toolset may be used by system integrated circuit (IC) integrators to rapidly create an individual IP core or an entire System of IP cores for a specific application. The EDA toolset provides timing diagrams, power and area aspects of each component and simulates with models coded to represent the components in order to run actual operation and configuration simulations. The EDA toolset may generate a Netlist and a layout targeted to fit in the space available on a target chip. The EDA toolset may also store the data representing the interconnect and logic circuitry on a machine-readable storage medium. The machine-readable medium may have data and instructions stored thereon, which, when executed by a machine, cause the machine to generate a representation of the physical components described above. This machine-readable medium stores an Electronic Design Automation (EDA) toolset used in a System-on-a-Chip design process, and the tools have the data and instructions to generate the representation of these components to instantiate, verify, simulate, and do other functions for this design.

Generally, the EDA toolset is used in two major stages of SOC design: front-end processing and back-end programming. The EDA toolset can include one or more of a RTL generator, logic synthesis scripts, a full verification testbench, and SystemC models.

Front-end processing includes the design and architecture stages, which includes design of the SOC schematic. The front-end processing may include connecting models, configuration of the design, simulating, testing, and tuning of the design during the architectural exploration. The design is typically simulated and tested. Front-end processing traditionally includes simulation of the circuits within the SOC and verification that they should work correctly. The tested and verified components then may be stored as part of a stand-alone library or part of the IP blocks on a chip. The front-end views support documentation, simulation, debugging, and testing.

In block 405, the EDA tool set may receive a user-supplied text file having data describing configuration parameters and a design for at least part of a tag logic configured to concurrently perform per-thread and per-tag memory access scheduling within a thread and across multiple threads. The data may include one or more configuration parameters for that IP block. The IP block description may be an overall functionality of that IP block such as an Interconnect, memory scheduler, etc. The configuration parameters for the Interconnect IP block and scheduler may include parameters as described previously.

The EDA tool set receives user-supplied implementation technology parameters such as the manufacturing process to implement component level fabrication of that IP block, an estimation of the size occupied by a cell in that technology, an operating voltage of the component level logic implemented in that technology, an average gate delay for standard cells in that technology, etc. The technology parameters describe an abstraction of the intended implementation technology. The user-supplied technology parameters may be a textual description or merely a value submitted in response to a known range of possibilities.

The EDA tool set may partition the IP block design by creating an abstract executable representation for each IP sub component making up the IP block design. The abstract executable representation models TAP characteristics for each IP sub component and mimics characteristics similar to those of the actual IP block design. A model may focus on one or more behavioral characteristics of that IP block. The EDA tool set executes models of parts or all of the IP block design. The EDA tool set summarizes and reports the results of the modeled behavioral characteristics of that IP block. The EDA tool set also may analyze an application's performance and allows the user to supply a new configuration of the IP block design or a functional description with new technology parameters. After the user is satisfied with the performance results of one of the iterations of the supplied configuration of the IP design parameters and the technology parameters run, the user may settle on the eventual IP core design with its associated technology parameters.

The EDA tool set integrates the results from the abstract executable representations with potentially additional information to generate the synthesis scripts for the IP block. The EDA tool set may supply the synthesis scripts to establish various performance and area goals for the IP block after the result of the overall performance and area estimates are presented to the user.

The EDA tool set may also generate an RTL file of that IP block design for logic synthesis based on the user supplied configuration parameters and implementation technology parameters. As discussed, the RTL file may be a high-level hardware description describing electronic circuits with a collection of registers, Boolean equations, control logic such as “if-then-else” statements, and complex event sequences.

In block 410, a separate design path in an ASIC or SOC chip design is called the integration stage. The integration of the system of IP blocks may occur in parallel with the generation of the RTL file of the IP block and synthesis scripts for that IP block.

The EDA toolset may provide designs of circuits and logic gates to simulate and verify the operation of the design works correctly. The system designer codes the system of IP blocks to work together. The EDA tool set generates simulations of representations of the circuits described above that can be functionally tested, timing tested, debugged and validated. The EDA tool set simulates the system of IP block's behavior. The system designer verifies and debugs the system of IP blocks' behavior. The EDA tool set tool packages the IP core. A machine-readable storage medium may also store instructions for a test generation program to generate instructions for an external tester and the interconnect to run the test sequences for the tests described herein. One of ordinary skill in the art of electronic design automation knows that a design engineer creates and uses different representations, such as software coded models, to help generating tangible useful information and/or results. Many of these representations can be high-level (abstracted and with less details) or top-down views and can be used to help optimize an electronic design starting from the system level. In addition, a design process usually can be divided into phases and at the end of each phase, a tailor-made representation to the phase is usually generated as output and used as input by the next phase. Skilled engineers can make use of these representations and apply heuristic algorithms to improve the quality of the final results coming out of the final phase. These representations allow the electric design automation world to design circuits, test and verify circuits, derive lithographic mask from Netlists of circuit and other similar useful results.

In block 415, next, system integration may occur in the integrated circuit design process. Back-end programming generally includes programming of the physical layout of the SOC such as placing and routing, or floor planning, of the circuit elements on the chip layout, as well as the routing of all metal lines between components. The back-end files, such as a layout, physical Library Exchange Format (LEF), etc. are generated for layout and fabrication.

The generated device layout may be integrated with the rest of the layout for the chip. A logic synthesis tool receives synthesis scripts for the IP core and the RTL design file of the IP cores. The logic synthesis tool also receives characteristics of logic gates used in the design from a cell library. RTL code may be generated to instantiate the SOC containing the system of IP blocks. The system of IP blocks with the fixed RTL and synthesis scripts may be simulated and verified. Synthesizing of the design with Register Transfer Level (RTL) may occur. The logic synthesis tool synthesizes the RTL design to create a gate level Netlist circuit design (i.e. a description of the individual transistors and logic gates making up all of the IP sub component blocks). The design may be outputted into a Netlist of one or more hardware design languages (HDL) such as Verilog, VHDL (Very-High-Speed Integrated Circuit Hardware Description Language) or SPICE (Simulation Program for Integrated Circuit Emphasis). A Netlist can also describe the connectivity of an electronic design such as the components included in the design, the attributes of each component and the interconnectivity amongst the components. The EDA tool set facilitates floor planning of components including adding of constraints for component placement in the space available on the chip such as XY coordinates on the chip, and routes metal connections for those components. The EDA tool set provides the information for lithographic masks to be generated from this representation of the IP core to transfer the circuit design onto a chip during manufacture, or other similar useful derivations of the circuits described above. Accordingly, back-end programming may further include the physical verification of the layout to verify that it is physically manufacturable and the resulting SOC will not have any function-preventing physical defects.

In block 420, a fabrication facility may fabricate one or more chips with the signal generation circuit utilizing the lithographic masks generated from the EDA tool set's circuit design and layout. Fabrication facilities may use a standard CMOS logic process having minimum line widths such as 1.0 um, 0.50 um, 0.35 um, 0.25 um, 0.18 um, 0.13 um, 0.10 um, 90 nm, 65 nm or less, to fabricate the chips. The size of the CMOS logic process employed typically defines the smallest minimum lithographic dimension that can be fabricated on the chip using the lithographic masks, which in turn, determines minimum component size. According to one embodiment, light including X-rays and extreme ultraviolet radiation may pass through these lithographic masks onto the chip to transfer the circuit design and layout for the test circuit onto the chip itself.

The EDA toolset may have configuration dialog plug-ins for the graphical user interface. The EDA toolset may have an RTL generator plug-in for the SocComp. The EDA toolset may have a SystemC generator plug-in for the SocComp. The EDA toolset may perform unit-level verification on components that can be included in RTL simulation. The EDA toolset may have a test validation testbench generator. The EDA toolset may have a dis-assembler for virtual and hardware debug port trace files. The EDA toolset may be compliant with open core protocol standards. The EDA toolset may have Transactor models, Bundle protocol checkers, OCPDis2 to display socket activity, OCPPerf2 to analyze performance of a bundle, as well as other similar programs.

As discussed, an EDA tool set may be implemented in software as a set of data and instructions, such as an instance in a software library callable to other programs or an EDA tool set consisting of an executable program with the software cell library in one program, stored on a non-transitory machine-readable medium. A machine-readable storage medium may include any mechanism that stores information in a form readable by a machine (e.g., a computer). For example, a machine-readable medium may include, but is not limited to: read only memory (ROM); random access memory (RAM); magnetic disk storage media; optical storage media; flash memory devices; DVD's; EPROMs; EEPROMs; FLASH, magnetic or optical cards; or any other type of media suitable for storing electronic instructions. The instructions and operations also may be practiced in distributed computing environments where the machine-readable media is stored on and/or executed by more than one computer system. In addition, the information transferred between computer systems may either be pulled or pushed across the communication media connecting the computer systems. In one embodiment, the software used to facilitate the algorithms discussed herein can be embodied onto a non-transitory machine-readable medium.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms may be written in a number of different software programming languages such as C, C+, or other similar languages. Also, an algorithm may be implemented with lines of code in software, configured logic gates in software, or a combination of both. In an embodiment, the logic consists of electronic circuits that follow the rules of Boolean Logic, software that contain patterns of instructions, or any combination of both.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

While some specific embodiments of the design have been shown the design is not to be limited to these embodiments. For example, most functions performed by electronic hardware components may be duplicated by software emulation. Thus, a software program written to accomplish those same functions may emulate the functionality of the hardware components in input-output circuitry. The design is to be understood as not limited by the specific embodiments described herein, but only by scope of the appended claims.

What is claimed is:

1. A mesochronous clock domain crossing communication interface in an interconnect network of an integrated circuit, comprising:
a control path that transfers a payload-validity bit from a sender clock domain to a mesochronously related receiver clock domain using a multiplicity of storage elements that are written by the sender domain and read by the receiver domain in the same order;
a separate control logic in each of the sender and receiver domains that each implements a pointer function that changes once per clock cycle, so that an order of writing signals is the same as reading the signals;
a clock-gating circuitry in the sender domain that blocks clock edges from arriving at the storage elements and a sender-domain pointer function when the pointer is at an initialization value and no new data is available in the current clock cycle, and no new data was available in an immediately prior at least N clock cycles, where N is the number of storage elements; and
a clock-gating circuitry in the receiver domain that blocks clock edges from arriving at a receiver-domain pointer function when the pointer is at an initialization value and no new data is available in the storage element addressed by the pointer in the current clock cycle, and no new data was available in the immediately prior at least N clock cycles.

2. The mesochronous clock domain crossing communication interface of claim 1, further comprising a sender data path which includes the multiplicity of storage elements, one or more multiplexers, and a send counter, where the one or more multiplexers receive data from the multiplicity of storage elements and transmits the data across the domain boundary when signaled by a datapath pointer counter, and wherein the send counter ensures that the storage elements are accessed sequentially, one at a time; and
at least one single storage element operating on the receiver clock that is not controlled by the receiver domain clock-gating control such that it is always clocked, wherein the one single storage element is in a path between at least one of the multiplicity of storage elements that is written when addressed by the sender-domain pointer when at its initialization value and the one or more multiplexers are indexed by the receive-domain pointer.

3. The mesochronous clock domain crossing communication interface of claim 2, wherein each of the multiplicity of storage elements is a D-type flip flop, including a D-input, a Q-output, and a clock input.

4. The mesochronous clock domain crossing communication interface of claim 1, further comprising a sender control including a detector which analyzes a sequence of inputs to the sender domain for a predefined number of cycles and communicates its results through a Boolean logic gate to a clock-gating latch, where the clock-gating latch feeds a binary counter which sequentially selects one of a multiplicity of storage elements within a FIFO that sends stored control data to a receiver control signal path.

5. The mesochronous clock domain crossing communication interface of claim 4, further comprising a sender datapath control which is returned to a predetermined initialization state when the detector determines that all data has been transmitted by the FIFO and the binary counter indicates that a predetermined number of cycles has occurred.

6. The mesochronous clock domain crossing communication interface of claim 5, wherein the clock-gating latch sends a signal to a power management system to indicate that the sender control is in a reduced power, idle state.

7. The mesochronous clock domain crossing communication interface of claim 5, wherein the detector determines that no new data has been input to the sender data path, or is being processed thereby, when multiple cycles of no incoming signal are detected as input for the immediately prior at least N clock cycles, where N is equal to the number of storage elements in the sender data path.

8. The mesochronous clock domain crossing communication interface of claim 4, wherein the receiver control signal path includes a multiplexer which receives signals from the multiplicity of storage elements within the FIFO in the sender control, through at least a first input including a free running flop, where the free running flop receives control information data from the first input, coupled with information from a datapath pointer counter, and where the multiplexer includes a number of inputs that is equal to the number of the storage elements within the FIFO in the sender control; and
wherein the free running flop creates a latency delay of between slightly greater than zero clock-cycles and less than two clock-cycles between the transmission of data by the sender control and the reading of the data by the receiver control signal path, where the latency delay minimizes the possibility of corrupted data transmission across the domain boundary.

9. The mesochronous clock domain crossing communication interface of claim 8, wherein the latency delay is equal to one clock-cycle.

10. The mesochronous clock domain crossing communication interface of claim 8, wherein the multiplexer passes information through a Boolean logic gate to a clock-gating latch, a binary counter, and a detector, where the detector indicates whether all data received by the receiver control signal path has been transmitted, or is being processed thereby, and where the binary counter signals the multiplexer to sequentially read data received from the multiplicity of storage elements within the FIFO in the sender control.

11. The mesochronous clock domain crossing communication interface of claim 10, wherein the datapath pointer counter signals one or more multiplexers in a sender data path to transmit data from one of the multiplicity of storage elements across the domain boundary each time data is read on the corresponding one of the multiplicity of storage elements within the FIFO in the sender control, where the counter changes once per clock cycle wrapping at modulo the number of the multiplicity of storage elements.

12. The mesochronous clock domain crossing communication interface of claim 10, wherein the receiver control signal path is returned to a predetermined initialization state when the detector indicates that all data has been transmitted from the FIFO within the control signal path and the binary counter indicates that a predetermined number of cycles have taken place, where the counter changes once per clock cycle wrapping at modulo the number of the multiplicity of storage elements.

13. The mesochronous clock domain crossing communication interface of claim 12, wherein the predetermined number of cycles is equal to the number of inputs to the multiplexer in the receiver control signal path.

14. The mesochronous clock domain crossing communication interface of claim 12, wherein the detector determines that all data has been transmitted from the FIFO in the receiver control signal path when multiple cycles of no incoming signal have been stored to all of the storage elements within the FIFO in the sender control.

15. The mesochronous clock domain crossing communication interface of claim 12, wherein the predetermined initialization state occurs when the free running flop initially receives data through an input from one of the multiplicity of storage elements within the FIFO in the sender control.

16. The mesochronous clock domain crossing communication interface of claim 12, wherein the sender control and the receiver control signal path are each clock-gated locally when 1) there is no new data is being presented to the sender control or the receiver control signal path, 2) the sender control or the receiver control signal path is at the predetermined initialization state, and 3) each of the immediately preceding predetermined number of clock-cycles in either the sender control or the receiver control signal path was idle, indicating that no new data items are expected to arrive into the sender control, and respectively that the receiver control signal path has emptied out all data items previously received from the sender control.

17. A non-transitory machine-readable storage medium that stores instructions, which when executed by the machine causes the machine to generate model representations of the mesochronous clock domain crossing communication interface of claim 1, which are used in an Electronic Design Automation process.

18. A method of transmitting data over a gated mesochronous clock domain boundary in an interconnect network of an integrated circuit, comprising:
receiving new data input from the interconnect into a sender domain that includes a sender data path and a sender control, where the sender data path temporarily stores the new data in a multiplicity of storage buffers, and the sender control utilizes clock-gating signals to validate the data;
synchronizing the data by sending control data sequentially from a multiplicity of storage elements within the sender control to corresponding inputs in a receiver control signal path within a receiver domain, where at least a first of the corresponding inputs includes a free running flop; and
signaling one or more multiplexers within the sender data path to sequentially transmit the data from the storage buffers across the domain boundary to the receiver domain according to the control data received from the multiplicity of storage elements within the sender control by the corresponding inputs in the receiver control signal path, wherein the one or more multiplexers receive signals from a datapath pointer counter in communication with the receiver control signal path.

19. The method of transmitting data over a gated mesochronous clock domain boundary of claim 18, wherein the free running flop creates a latency delay of between slightly greater than zero clock-cycles and less than two clock-cycles between the transmission of the control data by the FIFO within the sender control and the reading of the control data by the FIFO in the receiver control signal path, where the latency delay minimizes the possibility of corrupted data transmission across the domain boundary, and where the receiver domain uses a single free running flop to create the latency delay.

20. The method of transmitting data over a gated mesochronous clock domain boundary of claim 19, further comprising locally clock-gating each of the sender control and the receiver control signal path independently when 1) there is no new data being presented to the sender control or the receiver control signal path, 2) the sender control or the receiver control signal path is at a predetermined initialization state, and 3) each of an immediately preceding predetermined number of clock-cycles in either the sender control or the receiver control signal path was idle, indicating that no new control data is expected to arrive into the sender control, and respectively that the receiver control signal path has emptied out all control data items previously received from the sender control.

21. The method of transmitting data over a gated mesochronous clock domain boundary of claim 20, wherein the immediately preceding predetermined number of clock-cycles is equal to the number of storage elements in the FIFO within the sender control and the number of inputs in the FIFO within the receiver control signal path.

22. A method in an interconnect network of an integrated circuit of passing data payload over a mesochronous clock domain boundary, comprising:
passing the data payload over the mesochronous clock domain boundary from a sender module on one side of the boundary to a receiver module on the other side of the boundary, where the sender module has a storage buffer, which is clocked at a write clock frequency, where the sender module also has one or more multiplexers to pass the data payload over to the receiver module; where the sender sends validity control information to a storage register in the receiver module, which is clocked at a read clock frequency, where a source of the write clock frequency clocking the storage buffer feeding data payload to the multiplexer and control information to the storage register in the receiver module is mesochronous from a source of the read clock frequency clocking the receiver storage register, where the local power management protocol ensures that either module may enter into a powered off state only when that module is at its known initialization state and the module will not be processing new data, thereby eliminating a need to reset and initialize the other module when new data is being received or the module that was powered off is initialized.
